(19) United States
(12) Patent Application Publication
(10) Pub. No.: US 2026/0197039 A1
(43) Pub. Date: Jul. 9, 2026

(54) METHODS AND APPARATUSES FOR USE WITH MULTIPLE RECONFIGURABLE INTELLIGENT SURFACES

(71) Applicant: Huawei Technologies Co., Ltd., Shenzhen (CN)

(72) Inventors: Ahmad Mustafa Musa Abu Al Haija, Ottawa (CA); Mohammadhadi Baligh, Ottawa (CA)

(21) Appl. No.: 19/550,692

(22) Filed: Feb. 26, 2026

Related U.S. Application Data
(63) Continuation of application No. PCT/CN2023/115694, filed on Aug. 30, 2023.

(51) Int. Cl. H04B 7/04

(52) U.S. Cl. CPC H04B 7/04013

(57) ABSTRACT

Aspects of the present disclosure provide methods and device for utilizing reconfigurable intelligent surface (RIS) panels in the wireless network. Aspects of the present disclosure provide grouping multiple RIS panels together that may operate together to redirect signals by reflecting off a RIS surface or refract through the RIS surface. In some embodiments, a RIS device may include multiple RIS surfaces, or RIS edges, that may be controlled to redirect signals from multiple different base stations to multiple different user equipment.

### CROSS REFERENCE

This application is a continuation of International Application No. PCT/CN 2023/115694, filed on Aug. 30, 2023, the disclosure of which is hereby incorporated by reference in its entirety.

### TECHNICAL FIELD

The present disclosure relates generally to wireless communications, and in particular to methods and apparatuses for use with multiple reconfigurable intelligent surfaces.

### BACKGROUND

Metasurfaces have been investigated in optical systems for some time. These metasurfaces are capable of affecting a wavefront that impinges upon them. Some types of these metasurfaces are controllable, meaning through changing the electromagnetic properties of the surface, the properties of the surface can be changed. For example, manipulation of one or more of amplitude, phase, polarization and even frequency, may be achieved by changing an impedance or relative permittivity (and/or permeability) of the metamaterial. An example of a metasurface is a reconfigurable intelligent surface (RIS).

RISs have received a heightened research interest as a valuable technology for future wireless networks. An RIS consists of an array of configurable elements that can change one or more of the phase, amplitude, polarization, or even the frequency of the incident wave/signal. Such changes are achieved by configuring the RIS elements via bias voltages (or other methods like mechanical deformation and phase change materials), that are controlled by a control circuit connected to the RIS. Hence, for beamforming, RIS elements are configured to provide desired phase-shifts for the incident-waves to be redirected to a desired direction towards the destination.

However, a single RIS may not provide a wide range of reflection with sufficient gain considering some incident and reflected angles. An incident angle may be defined as the angle between a line parallel to the RIS, and starts from the right or left of this parallel line depending on which direction is closer to the source, and a line from the source. Similarly, a reflected angle may be defined as the angle between a line parallel to the RIS and a line toward the destination. An effective antenna aperture that is proportional to the cosine of both impinging and reflection angles may be low for some incident and reflected angles. A single RIS may not have sufficient resolution, accuracy and range of the added phases of RIS elements to adequately manipulate the incident angles. Hence, it is of interest to investigate a combined set of multiple RIS structures and their advantages in different deployment scenarios include, but are not limited to, point-to-point communication (e.g. base station-UE communication), Handover (HO), and dual connectivity (DC) communication.

### SUMMARY

Aspects of the present disclosure may provide methods, apparatuses and devices for reducing the beam switching by having a group of RISs that are in proximity to one another that may receive the signals from different directions/sources and intelligently redirect the signals to one or more destinations. The group of RISs are in proximity to one another such that the following may happen: (i) the RISs may be controlled using a same controller, the RISs individual controllers may cooperate, or the RIS controllers of the group of RISs receive instructions from the same entity, enabling the main entity to jointly control the RIS surfaces and (ii) the RIS surfaces are in the reactive near field of each other where the near field is defined as closer than 2D²/λ, where D is the largest linear dimension (such as the diameter of a rectangular RIS surface) of all the RIS surfaces involved and λ is the wavelength of the signal. By controlling transmission modes, such as reflection off of a RIS surface or refraction through a RIS surface of one or more RISs, a UE may remain connected with one base station. This may be advantageous to avoid a handover ping-pong (HOPP) problem that may occur when a UE is within a region served by multiple base stations. Furthermore, by switching the transmission modes of one or more RISs at different times, dual connectivity may be enabled between a UE and multiple base stations while using a same beam to receive signals from both base stations as the UE is directing the UE receive beam in a singular direction toward the group of RISs such that the UE receives the signals from the group of RISs, without having to change the UE receive beam direction.

Some aspects of the present disclosure provide a method includes transmitting, by a network side device, first configuration information to a set of Reconfigurable Intelligent Surfaces (RISs) in proximity to one another, each RIS of the set serving a region of a plurality of regions that is covered by the set of RISs, the first configuration information comprising information for configuring the set of collocated RISs to redirect a signal between the network side device and a terminal side device; transmitting, by the network side device, second configuration information to the terminal side device, the second configuration information including information to configure transmission of at least one reference signal (RS) between the network side device and the terminal side device in at least one time slot.

In some embodiments, the first configuration information includes at least one of: a number of time slots during which the at least one reference signal will be transmitted; an identification of a mode in which each RIS of the set of RISs is to function in each time slot or sub-slot; wherein: each RIS is capable of redirecting an incident signal from the network side device to another RIS of the set of RISs or in a direction to partially or fully cover a region covered by the RIS redirecting the incident beam; or each RIS is capable of redirecting a redirected signal from a first RIS toward a second RIS of the set of RISs or a direction to partially or fully cover a region covered by the first RIS redirecting the redirected incident beam.

In some embodiments, the first configuration information includes a number of sub-slots per time slot during which the at least one reference signal will be transmitted.

In some embodiments, the second configuration information includes at least one of: an identification of a sequence of reference signals; an indication of timing for transmission of a reference signal; an indication of periodicity of transmission of a reference signal; or an identification of an association between a RIS of the set of RISs and a timing for a group of reference signals to be redirected by the RIS to cover at least one region of the plurality of regions covered by the set of collated RISs.

In some embodiments, transmission of the at least one RS between the network side device and the terminal side device includes: a downlink transmission of the at least one reference signal from the network side device to the terminal side device; or an uplink transmission of the at least one reference signal from the terminal side device to the network side device.

In some embodiments, the at least one reference signal transmitted in the downlink transmission includes at least one of a channel state information reference signal (CSI-RS), a tracking reference signal (T-RS), a phase tracking (PT-RS), or a demodulation reference signal (DMRS).

In some embodiments, the method further includes: transmitting, by the network side device, the at least one reference signal in the at least one time slot in a direction toward the set of RISs.

In some embodiments, the method further includes: receiving, by the network side device, feedback information from the terminal side device.

In some embodiments, the feedback information includes at least one of: an identification of a measured or determined channel property for the at least one time slot corresponding to the at least one reference signal; or an identification of one or more time slot of the at least one time slot corresponding to one or more of the at least one reference signal that satisfies a channel property threshold.

In some embodiments, the measured or determined channel property is any one or more of: reference signal received power (RSRP), channel quality indicator (CQI), channel state information (CSI), reference signal received quality (RSRP), or received signal strength indicator (RSSI).

In some embodiments, the method further includes: based on the feedback information, determining, by the network side device, a transmission scheme for transmission between the network side device and terminal side device, wherein the transmission scheme is at least one of: direct communication between the network side device and the terminal side device; or communication between the network side device and the terminal side device via a path that includes redirection by one or more RIS of the set of RISs.

In some embodiments, the method further includes: transmitting, by the network side device, third configuration information to the terminal side device notifying the terminal side device of the transmission scheme.

In some embodiments, the method further includes: transmitting or receiving data by using the transmission scheme.

In some embodiments, the method further includes: refining directionality of beams between at least two of the network side device, the terminal side device and the set of RISs.

In some embodiments, the method further includes: receiving, by the network side device, additional first configuration information from a second network side device to be provided to the set of RISs as part of the first configuration information.

In some embodiments, the second configuration information further includes: an indication of a group of reference signals from the first network side device and the second network side device to be received via the same beam at the terminal side device; and an indication of a relative average delay difference between reference signals of the same group from a first network side device and a second network side device to be received at the terminal side device.

In some embodiments, the transmission scheme is at least one of one or more of: direct communication between the network side device and terminal side device; communication between the network side device and terminal side device via a path that includes the set of RISs initiate dual connectivity for the terminal side device with both of the network side device and the second network side device; or initiate a handover to the second network side device.

In some embodiments, the at least one reference signal transmitted in the uplink transmission includes a sounding reference signal (S-RS) or a demodulation reference signal (DMRS).

In some embodiments, the method further includes: receiving, by the network side device, the at least one reference signal in the at least one time slot from a direction of the set of RISs.

In some embodiments, the method further includes: measuring signal strength of the at least one received reference signal in the at least one time slot.

In some embodiments, the method further includes: based on the measured signal strength of the at least one received reference signal or determined signal quality based on signal measurement, determining, by the network side device, a transmission scheme for transmission between the network side device and terminal side device, wherein the transmission scheme is at least one of one or more of: direct communication between the network side device and the terminal side device; or communication between the network side device and the terminal side device via a path that includes redirection by the set of RISs.

In some embodiments, the method further includes: transmitting, by the network side device, third configuration information to the terminal side device notifying the terminal side device of the transmission scheme.

In some embodiments, the method further includes: transmitting or receiving data between the network side device and terminal side device using the transmission scheme.

In some embodiments, the method further includes: refining directionality of beams between at least two of the network side device, the terminal side device and the set of RISs.

Some aspects of the present disclosure provide an apparatus for supporting network communication, including a processor and a computer-readable medium. The computer-readable medium has stored thereon, computer executable instructions, that when executed cause the processor to perform the method as described above.

Some aspects of the present disclosure provide a non-transitory computer readable storage medium, wherein the computer readable storage medium stores instructions that, when executed by a processor of an apparatus, cause the apparatus to perform a method as described above.

Some aspects of the present disclosure provide a method including a terminal side device receiving configuration information from a network side device, the configuration information including information to configure transmission of at least one RS between the network side device and the terminal side device in at least one time slot via a set of RISs, each RIS of the set serving a region of a plurality of regions that is covered by the set of RISs.

In some embodiments, the configuration information includes at least one of: an identification of a sequence of reference signals; an indication of timing for transmission of a reference signal; indication of periodicity of transmission of a reference signal; an identification of an association between a RIS of the set of RISs and a timing for a group of reference signals to be redirected by that RIS to cover at least one region of the plurality of regions covered by the set of RISs.

In some embodiments, transmission of the at least one RS between the network side device and the terminal side device includes: a downlink transmission of the at least one reference signal from the network side device to the terminal side device; or an uplink transmission of the at least one reference signal from the terminal side device to the network side device.

In some embodiments, the at least one reference signal transmitted in the downlink transmission includes at least one of a CSI-RS, a T-RS, a PT-RS, or a DMRS.

In some embodiments, the method further includes: receiving, by the terminal side device, the at least one reference signal in the at least one time slot from a direction of the set of RISs.

In some embodiments, the method further includes: measuring, by the terminal side device, signal strength of the at least one received reference signal in the at least one time slot.

In some embodiments, the method further includes: transmitting, by the terminal side device, feedback information to the network side device.

In some embodiments, the feedback information includes at least one of: an identification of a measured or determined channel property for the at least one time slot corresponding to the at least one reference signal; or an identification of one or more time slot of the at least one time slot corresponding to one or more reference signal that satisfies a channel property threshold.

In some embodiments, the measured or determined channel property is any one or more of: RSRP, CQI, CSI, RSRP, or RSSI.

In some embodiments, the method further includes: receiving, by the terminal side device, second configuration information from the network side device notifying the terminal side device of a transmission scheme for transmission between the network side device and terminal side device, wherein the transmission scheme is at least one of one or more of: direct communication between the network side device and the terminal side device; or communication between the network side device and the terminal side device via a path that includes redirection by one or more RIS of the set of RISs.

In some embodiments, the method further includes: transmitting or receiving data between the network side device and terminal side device using the transmission scheme.

In some embodiments, the method further includes: refining directionality of beams between at least two of the network side device, the terminal side device and the set of RISs.

In some embodiments, the configuration information includes additional configuration information from a second network side device to configure transmission of at least one reference signal (RS) between the second network side device and the terminal side device in at least one time slot via the set of RISs.

In some embodiments, the first configuration information further includes: an indication of a group of reference signals from the first network side device and the second network side device to be received via the same beam at the terminal side device; and an indication of a relative average delay difference between reference signals of the same group from a first network side device and a second network side device to be received at the terminal side device.

In some embodiments, the transmission scheme is at least one of one or more of: direct communication between the network side device and terminal side device; communication between the network side device and terminal side device via a path that includes the set of RISs; initiate dual connectivity for the terminal side device with both of the network side device and the second network side device; or initiate a handover to the second network side device.

In some embodiments, the at least one reference signal transmitted in the uplink transmission includes at least one of a S-RS or a DMRS.

In some embodiments, the method further includes: transmitting, by the terminal side device, the reference signal in the at least one time slot in a direction toward the set of RISs.

In some embodiments, the method further includes: receiving, by the terminal side device, second configuration information from the network side device notifying the terminal side device of a transmission scheme for transmission between the network side device and terminal side device, wherein the transmission scheme is at least one of one or more of: direct communication between the network side device and the terminal side device; or communication between the network side device and the terminal side device via a path that includes redirection by the set of RISs.

In some embodiments, the method further includes: transmitting or receiving data by using the transmission scheme.

In some embodiments, the method further includes: refining directionality of beams between at least two of the network side device, the terminal side device and the set of RISs.

Some aspects of the present disclosure provide an apparatus for supporting network communication, including a processor and a computer-readable medium. The computer-readable medium has stored thereon, computer executable instructions, that when executed cause the processor to perform the method as described above.

Some aspects of the present disclosure provide a non-transitory computer readable storage medium, wherein the computer readable storage medium stores instructions that, when executed by a processor of an apparatus, cause the apparatus to perform the method as described above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a transmission channel between a source and destination in which a planar array of configurable elements is used to redirect signals according to an aspect of the disclosure.

FIG. 2 is a schematic diagram of a communication system in which embodiments of the present disclosure may occur.

FIG. 3 is another schematic diagram of a communication system in which embodiments of the present disclosure may occur.

FIG. 4 illustrates examples of multiple edge RIS devices in which embodiments of the present disclosure may occur.

FIG. 5 is a block diagram illustrating units or modules in a device in which embodiments of the present disclosure may occur.

FIG. 6 is a block diagram of an example reconfigurable intelligent surface (RIS) device.

FIG. 7 is a block diagram illustrating units or modules in a device in which embodiments of the present disclosure may occur.

FIG. 8 is an example of base station-UE communication via a RIS.

FIG. 9 is a schematic diagram showing a handover ping-pong (HOPP) type problem at high frequency that may happen between a UE and two base stations when the UE frequently moves within proximity to the two base stations.

FIG. 10 is a schematic diagram illustrating how when using a RIS box, a UE may be served by one base station with proper mode selection for different edges of RIS box.

FIG. 11 is a schematic diagram showing two base stations communicating with multiple UEs via a six edge RIS box according to aspects of the present disclosure.

FIG. 12 illustrates an example of how regions may be divided based on various edges of a six edge RIS box.

FIG. 13 illustrates RIS box SEMS in different time slots to provide coverage of different regions via one or more base stations according to aspects of the present disclosure.

FIGS. 14A and 14B illustrate examples of HO between two base stations over a first duration and then over a second duration as a UE moves between different RIS box regions according to aspects of the present disclosure.

FIG. 15 illustrates a portion of a communication network including a base station, multiple UEs and a RIS box to facilitate communication according to aspects of the present disclosure.

FIG. 16 illustrates an example of CSI-RSs time allocation for transmission that is redirected by different RIS edges of a RIS box and without redirection by a RIS box according to aspects of the present disclosure.

FIG. 17 illustrates a signal flow diagram for CSI-RS measurement at a UE and data transmission between a base station and the UE with the help of a RIS box according to aspects of the present disclosure.

FIG. 18 illustrates a signal flow diagram for S-RS measurement at a base station and data transmission between the base station and a UE with the help of a RIS box according to aspects of the present disclosure.

FIG. 19 illustrates a signal flow diagram for CSI-RS and data transmission from one or more base station using the SEMS scheme at a RIS box according to aspects of the present disclosure.

FIG. 20 illustrates timing for different CSI-RS transmission and possible grouping for 1) CSI-RS from each of two base stations, and 2) when CSI-RS may be received via the same beam (QCL-type D, where QCL stands for Quasi Co Location) and may have the same average delay (CQL-type C) according to aspects of the present disclosure.

FIG. 21 illustrates a portion of a communication network including a base station, multiple UEs and a RIS box showing CSI-RSs from a first base station that may be sent directly to a UE or via a RIS box according to aspects of the present disclosure.

FIG. 22 illustrates timing for different CSI-RS and data transmission with possible grouping for 1) CSI-RS from each base station, and 2) quantitative CSI-RS measurements according to aspects of the present disclosure.

### DETAILED DESCRIPTION OF THE ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Controllable metasurfaces are referred to by different names such as reconfigurable intelligent surface (RIS), large intelligent surface (LIS), intelligent reflecting surface (IRS), digital controlled surface (DCS), intelligent passive mirrors, and artificial radio space. While in subsequent portions of this document RIS is used most frequently when referring to these metasurfaces, it is to be understood then this is for simplicity and is not indented to limit the disclosure.

A RIS can realize “smart radio environment” or “smart radio channel” i.e. the environment radio propagation properties can be controlled to realize personalized channel for desired communication. The RIS may be established among multiple base stations to produce large scale smart radio channels that serve multiple users. With a controllable environment, RISs may first sense environment information and then feeds the environment information that has been sensed back to the system. According to this information, the system may optimize transmission mode parameters and RIS parameters through smart radio channels, at one or more of the transmitter (whether the base station or a UE), the channel and the receiver (whether the UE or a base station).

Because of beamforming gains associated with RISs, exploiting smart radio channels may significantly improve one or more of link quality, system performance, cell coverage, and cell edge performance in wireless networks. Not all RIS panels use the same structure. Different RIS panels may be designed with different types of phase adjusting capabilities that range from continuous phase control, to discrete control with multiple levels.

Another application of RISs is in transmitters that directly modulate incident radio one or more wave properties, such as phase, amplitude polarization and/or frequency without a need for active components as used in RF chains in traditional multiple input multiple output (MIMO) transmitters. RIS based transmitters have many merits, such as simple hardware architecture, low hardware complexity, low energy consumption and high spectral efficiency. Therefore, RISs provide a new direction for extremely simple transmitter design in future radio systems.

RIS assisted MIMO also may be used to assist fast beamforming with the use of accurate positioning, or to conquer blockage effects through CSI acquisition in mmWave systems. Alternatively, RIS assisted MIMO may be used in non-orthogonal multiple access (NOMA) in order to improve reliability at very low signal to noise ratio (SNR), accommodate more users and enable higher modulation schemes. RIS is also applicable to native physical security transmission, wireless power transfer or simultaneous data and wireless power transfer, and flexible holographic radios.

The ability to control the environment and network topology through strategic deployment of RISs, and other non-terrestrial (NT) and controllable nodes is an important paradigm shift in MIMO system, such as 6G MIMO. Such controllability is in contrast to the traditional communication paradigm, where transmitters and receivers adapt their communication methods to achieve the capacity predicted by information theory for the given wireless channel. Instead, by controlling the environment and network topology, MIMO aims to be able to change the wireless channel and adapt the network condition to increase the network capacity.

One way to control the environment is to adapt the topology of the network as user distribution and traffic patterns change over time. This involves utilizing high altitude pseudo satellites (HAPs), unmanned ariel vehicles (UAVs) and drones when and where it is necessary.

RIS-assisted MIMO utilizes RISs to enhance the MIMO performance by creating a smart radio channels. To extract full potential of RIS-assisted MIMO, a system architecture and more efficient scheme are provided in the present disclosure.

A RIS may include many small configurable elements, often comparable in size with the wavelength (for example, from 1/10 to a couple of wavelengths). Each element can be controlled independently. The control mechanism may be, for example, a bias voltage or a driving current to change the characteristics of the element. The combination of the control voltages for all elements (and hence the effective response) may be referred to as the RIS pattern. This RIS pattern may control the behavior of the RIS including at least one of the width, shape and direction of the beam, which is referred to as the beam pattern.

The controlling mechanism of the RIS often is through controlling the phase of a wavefront incident on the surface and reflected by the surface. Other techniques of controlling the RIS include attenuating reflection of the amplitude to reduce the reflected power and “switching off” the surface. Attenuating the power and switching off the surface can be realized by using only a portion of the RIS, or none of the RIS, for reflection while applying a random pattern to the rest of the panel, or a pattern that reflects the incident wavefront in a direction that is not in a desired direction.

In some portions of this disclosure, RIS may be referred to as a set of configurable elements arranged in a linear array or a planar array. Nevertheless, the analysis and discussions are extendable to two or three dimensional arrangements (e.g., circular array). A linear array is a vector of N configurable elements and a planar array is a matrix of N×M configurable elements, where N and M are non-zero integers. These configurable elements have the ability to redirect a wave/signal that is incident on the linear or planar array by changing the phase of the wave/signal. The configurable elements are also capable of changing the amplitude, polarization, or even the frequency of the wave/signal. In some planar arrays these changes occur as a result of changing bias voltages that control the individual configurable elements of the array via a control circuit connected to the linear or planar array. The control circuit that enables control of the linear or planar array may be connected to a communications network that base stations and UEs communicating with each other are part of. For example, the network that controls the base station may also provide configuration information to the linear or planar array. Control methods other than bias voltage control include, but are not limited to, mechanical deformation and phase change materials.

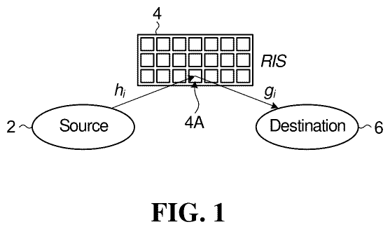

Because of their ability to manipulate the incident wave/signal, the low cost of these types of RIS, and because these types of RIS require small bias voltages, RIS have recently received heightened research interest in the area of wireless communication as a valuable tool for beamforming and/or modulating communication signals. A basic example for RIS utilization in beamforming is shown in FIG. 1 where each RIS configurable element 4a (unit cell) may change the phase of the incident wave from source such that the reflected waves from all of the RIS elements are aligned to the direction of the destination to increase or maximize its received signal strength (e.g. maximize the signal to noise ratio). Such a reflection via the RIS may be referred to as reflect-array beamforming. In some embodiments, the planar array of configurable elements, which may be referred to as a RIS panel, can be formed of multiple co-planar RIS sub-panels. In some embodiments, the RIS may be considered as an extension of the base station (BS) antennas or a type of distributed antenna. In some embodiments, the RIS can also be considered as a type of passive relay.

Aspects of the present disclosure provide methods and device for utilizing RIS panels in the wireless network to take advantage of the RIS capabilities, intelligence, coordination and speed, and thereby provide solutions having different signaling details and capability requirements.

FIG. 1 illustrates an example of a planar array of configurable elements, labelled in the figure as RIS 4, in a channel between a source 2, or transmitter, and a destination 6, or receiver. The channel between the source 2 and destination 6 include a channel between the source 2 and RIS 4 identified as hᵢ and a channel between the RIS 4 and destination 6 identified as gᵢ for the i^{th} RIS configurable element (configurable element 4a) where i∈{1,2,3, . . . , N*M} assuming the RIS consists of N*M elements or unit cells. A wave that leaves the source 2 and arrives at the RIS 4 can be said to be arriving with a particular AoA. When the wave is reflected by the RIS 4, the wave can be considered to be leaving the RIS 4 with a particular AoD. In some embodiments, the planar array of configurable elements, which may be referred to as a RIS panel, can be formed of multiple co-planar RIS sub-panels. In some embodiments, the RIS can be considered as an extension of the BS antennas or a type of distributed antenna. In some embodiments, the RIS can also be considered as a type of passive relay. While FIG. 1 has two dimensional planar array RIS 4 and shows a

channel hᵢ and a channel gᵢ, the figure does not explicitly show an elevation angle and azimuth angle of the transmission from the source 2 to RIS 4 and the elevation angle and azimuth angle of the redirected transmission from the RIS 4 to the destination 6. In the case of a linear array, there may be only one angle to be concerned about, i.e. the azimuth angle.

In wireless communications, the RIS 4 can be deployed as 1) a reflector between a transmitter and a receiver, as shown in FIG. 1, or as 2) a transmitter (integrated at the transmitter) to help implement a virtual MIMO system as the RIS helps to direct the signal from a feeding antenna.

Aspects of the present disclosure may provide methods, apparatuses and devices for reducing the beam switching by having a group of RISs that are in proximity to one another that may receive the signals from different directions/sources and intelligently redirect the signals to one or more destinations. The group of RISs are in proximity to one another such that the following may happen: (i) the RISs may be controlled using a same controller, the RISs individual controllers may cooperate, or the RIS controllers of the group of RISs receive instructions from the same entity, enabling the main entity to jointly control the RIS surfaces and (ii) the RIS surfaces are in the reactive near field of each other where the near field is defined as closer than 2D²/λ, where D is the largest linear dimension (such as the diameter of a rectangular RIS surface) of all the RIS surfaces involved and λ is the wavelength of the signal. By controlling transmission modes, such as reflection off of a RIS surface or refraction through a RIS surface of one or more RISs, a UE may remain connected with one base station. This may be advantageous to avoid a handover ping-pong (HOPP) problem that may occur when a UE is within a region served by multiple base stations. Furthermore, by switching the transmission modes of one or more RISs at different times, dual connectivity may be enabled between a UE and multiple base stations while using a same beam to receive signals from both base stations as the UE is directing the UE receive beam in a singular direction toward the group of RISs such that the UE receives the signals from the group of RISs, without having to change the UE receive beam direction.

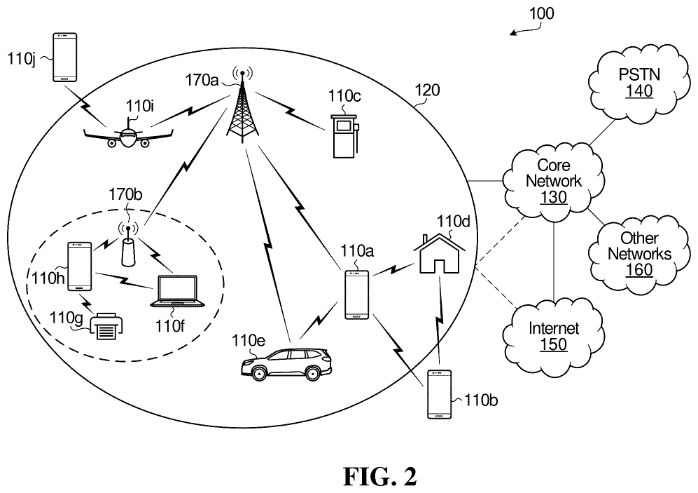

FIGS. 2, 3, 5 and 6 following below provide context for the network and device that may be in the network and that may implement aspects of the present disclosure.

Referring to FIG. 2, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

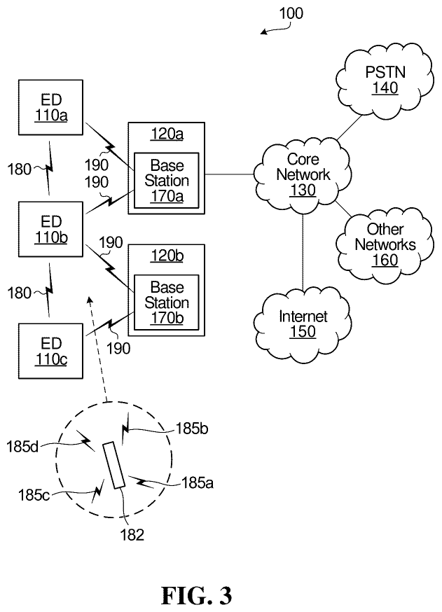

FIG. 3 illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a PSTN 140, the Internet 150, and other networks 160. While certain numbers of these components or elements are shown in FIG. 3, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, terminal side device, or consumer electronics device.

FIG. 3 illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 3, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a UE, WTRU, mobile station, fixed or mobile subscriber unit, cellular telephone, STA, MTC device, PDA, smartphone, laptop, computer, tablet, wireless sensor, or consumer electronics device.

In FIG. 3, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 3, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b, 172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b, 172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA20001X, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

Also shown in FIG. 3 is a RIS 182 located within the serving area of base station 170b. A first signal 185a is shown between the base station 170b and the RIS 182 and a second signal 185b is shown between the RIS 182 and the ED 110b, illustrating how the RIS 182 might be located within the uplink or downlink channel between the base station 170b and the ED 110b. Also shown is a third signal 185c between the ED 110c and the RIS 182 and a fourth signal 185d is shown between the RIS 182 and the ED 110b, illustrating how the RIS 182 might be located within the SL channel between the ED 110c and the ED 110b.

While only one RIS 182 is shown in FIG. 3, it is to be understood that any number of RIS could be included in a network.

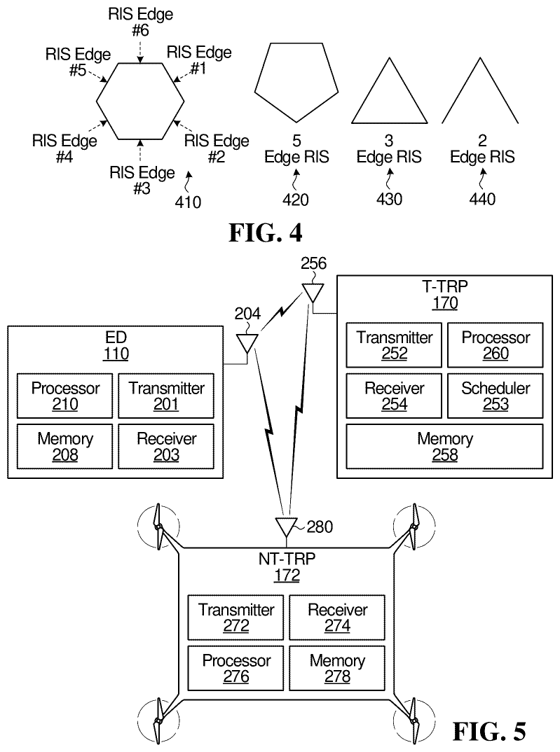

Furthermore, while only a single RIS is shown in FIG. 3, it is to be understood that multiple RISs, which may be referred to as a RIS box, for example as shown in FIG. 4, may be located in the network 100. In addition, multiple RIS boxes may be located in the network 100. A RIS box refers to multi-RIS structure where two or more RISs, where each RIS may be referred to as a RIS edge, are arranged together such that the RISs redirect an incident signal in different directions. An incident signal may be directed by reflecting off of the impinging surface or refracting through the impinging surface. Several examples of RIS box shapes are shown in FIG. 4. RIS box 410 is shown having 6 edges, i.e. RIS Edge #1 to RIS Edge #6. RIS box 420 is shown having 5 edges. RIS box 430 is shown having 3 edges. RIS box 440 is shown having 2 edges. The multiple RISs in the RIS box are in proximity to one another such that: (i) the RISs may be controlled using a same controller, the RISs individual controllers may cooperate, or the RIS controllers of the group of RISs receive instructions from the same entity, enabling the main entity to jointly control the RIS surfaces and (ii) the RIS surfaces are in the reactive near field of each other where the near field is defined as closer than 2D²/λ, where D is the largest linear dimension (such as the diameter of a rectangular RIS surface) of all the RIS surfaces involved and λ is the wavelength of the signal. RIS boxes may be installed in indoor or outdoor environments (e.g. on light poles). While the examples in FIG. 4 are shown in a cross sectional view and it is intended that the edges are flat surfaces, it should be understood that the edges may consist of curved surfaces to increase the beamforming capabilities or covered areas. In this context, the RIS edges may have multiple functionalities such as reflection, refraction, and absorption empowered by one or multiple layers of metamaterials.

In some embodiments, the signal is transmitted from a terrestrial base station (BS) to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 5 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 5, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2 or 3). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 5. FIG. 5 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

While not shown in FIG. 5, a RIS, or multiple RISs in the form of a RIS box as shown in FIG. 4, may be located between the ED 110 and the NT-TRP 172 or between the ED 110 and the T-TRP 170, in a similar manner as RIS 182 is shown between the EDs 110 and base station 170b in FIG. 3. A RIS may be located between the NT-TRP 172 and the T-TRP 170 to aid in communication between the two TRPs.

Additional details regarding the EDs 110, T-TRP 170, and NT-TRP 172 are known to those of skill in the art. As such, these details are omitted here.

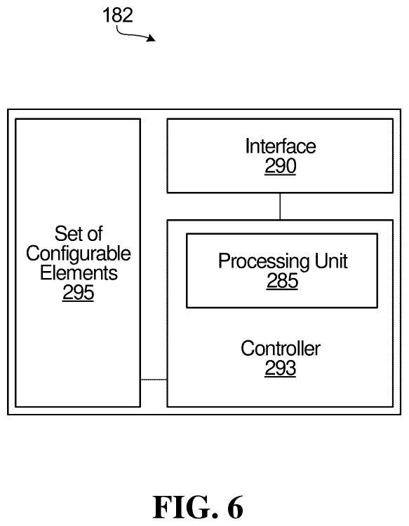

FIG. 6 illustrates an example RIS device that may implement the methods and teachings according to this disclosure. In particular, FIG. 6 illustrates an example RIS device 182. These components could be used in the system 100 shown in FIGS. 2 and 3, the system shown in FIG. 5, or in any other suitable system.

As shown in FIG. 6, the RIS device 182, which may also be referred to as a RIS panel, includes a controller 293 that includes at least one processing unit 285, an interface 290, and a set of configurable elements 295. The set of configurable elements are arranged in a single row or a grid or more than one row, which collectively form the redirecting surface of the RIS panel. The configurable elements can be individually addressed to alter the direction of a wavefront that impinges on each element. RIS redirection properties (such as beam direction, beam width, frequency shift, amplitude, and polarization) are controlled by RF wavefront manipulation that is controllable at the element level, for example via the bias voltage at each element to change the phase of the redirected wave. This control signal forms a pattern at the RIS. To change the RIS redirecting behavior, the RIS pattern needs to be changed. While the set of configurable elements 295 is described as a single row or a grid or more than one row, which collectively form the redirecting surface of the RIS panel, it is to be understood that such a RIS device 182 may be a single edge RIS or there may be multiple edges all controlled by a single control 293, such that the RIS device 182 is a RIS box. Alternatively, multiple RIS devices 182, each with their own controller 293 may collectively form a RIS box.

Connections between the RIS, or RIS box, and a UE can take several different forms. In some embodiments, the connection between the RIS, or RIS box, and the UE is a redirecting channel where a signal from the BS is redirected to the UE or a signal from the UE is redirected to the BS. In some embodiments, the connection between the RIS and the UE is a redirecting connection with passive backscattering or modulation. In such embodiments a signal from the UE is redirected by the RIS, or RIS box, but the RIS modulates the signal by the use of a particular RIS pattern. Likewise, a signal transmitted from the BS may be modulated by the RIS, or RIS box, before it reaches the UE. In some embodiments, the connection between the RIS, or RIS box, and the UE is a network controlled sidelink connection. This means that that the RIS, or RIS box, may be perceived by the UE as another device like a UE, and the RIS, or RIS box, forms a link similar to two UEs, which is scheduled by the network. In some embodiments, the connection between the RIS, or RIS box, and the UE is an ad hoc in-band/out-of-band connection.

A RIS device, also referred to as a RIS panel, is generally considered to be the RIS and any electronics that may be used to control the configurable elements and hardware and/or software used to communication with other network nodes. However, the expressions RIS, RIS panel and RIS device may be used interchangeably in this disclosure to refer to the RIS device used in a communication system. As indicated above, multiple RIS devices grouped in proximity and controlled individually or by a common controller, may be considered a RIS box.

The processing unit 285 implements various processing operations of the RIS 182, such as receiving the configuration signal via interface 290 and providing the signal to the controller 293. The processing unit 285 could, for example, include a microprocessor, microcontroller, digital signal processor, field programmable gate array, or application specific integrated circuit.

While this is a particular example of a RIS, it should be understood that the RIS may take different forms and be implemented in different manner than shown in FIG. 6. The RIS 182 ultimately needs a set of configurable elements that can be configured as described to operate herein.

FIG. 6 illustrates an interface 290 to receive configuration information from the network. In some embodiments, the interface 290 enables a wired connection to the network. The wired connection may be to a base station or some other network-side device. In some embodiments, the wired connection is a propriety link, i.e. a link that is specific to a particular vendor or supplier of the RIS equipment. In some embodiments, the wired connection is a standardized link, e.g. a link that is standardized such that anyone using the RIS uses the same signaling processes. The wired connection may be an optical fiber connection or metal cable connection.

In some embodiments, the interface 290 enables a wireless connection to the network. In some embodiments, the interface 290 may include a transceiver that enables RF communication with the BS or with the UE. In some embodiments, the wireless connection is an in-band propriety link. In some embodiments, the wireless connection is an in-band standardized link. The transceiver may operate out of band or using other types of radio access technology (RAT), such as Wi-Fi or BLUETOOTH. In some embodiments, the transceiver is used for low rate communication and/or control signaling with the base station. In some embodiments, the transceiver is an integrated transceiver such as an LTE, 5G, or 6G transceiver for low rate communication. In some embodiments, the interface could be used to connect a transceiver or sensor to the RIS.

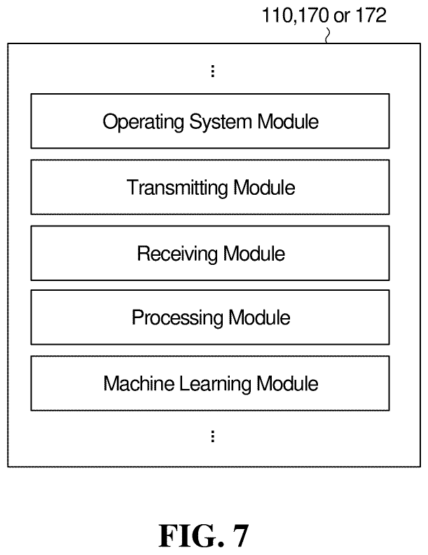

One or more steps of the embodiment methods provided herein may be performed by corresponding units or modules, according to FIG. 7. FIG. 7 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial network based sensing could provide intelligent context-aware networks to enhance the UE experience. For example, terrestrial networks based sensing and non-terrestrial network based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data intensive. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

As described above with reference to FIG. 4, multiple RIS may be combined and form a device having multiple RIS edges. Smart Edge-Mode Switching (SEMS) refers to configuring different RIS edges of a multiple RIS device for redirection of at least one incident signal from one or more directions associated with one or more sources. In the expression “Smart Edge-Mode Switching”, “Edge-mode switching” refers to switching one or more of the RIS edge between different modes, while “smart” refers to selection of each RIS edge mode to enable redirection in a desired direction. Examples of two modes are a reflection mode and a refraction mode.

Multiple RISs located in different locations, i.e. spatially separated, may be utilized for applications such as 1) routing the source signal among multiple RISs to the destination and 2) for cognitive radio channel. However, a multiple RIS structure having multiple RIS located in proximity to one another may have other applications such as 1) increasing range of a signal redirected by the RIS, which my enable improved coverage, 2) improving overall link beamforming gain, 3) improved interference suppression and 4) facilitating connectivity with two base stations, also referred to as dual-connectivity (DC), and a handover (HO) process with the same beam at the UE instead of switching the UE beam to receive signals from different BSs.

Coordinated beam switching (CBS) proposed in Long Term Evolution (LTE) to manage HO ping-pong (HOPP) and facilitate communication between different base stations and UEs without interference between the base station signals at the UEs. However, when operating at high frequency and with massive MIMO systems, CBS requires more frequency beam switching at the communicating nodes (UEs and BSs).

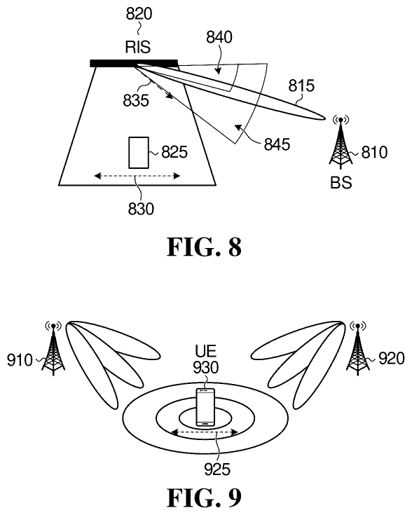

A single RIS may not sufficiently redirect the signals to the destination with a desirable gain. For example, consider the scenario in FIG. 8, which illustrates a base station 810 transmitting a signal on a beam 815. The beam is redirected by a RIS 820. A UE 825 is shown within an area of coverage of the RIS 810. The UE 825 may be moving along the directions indicated by arrow 830. An instance of reflection that may be desirable is a reflected signal 835 having a target directed angle 845 that is far from a mirror-like specular reflection angle. For example, an incident angle=30 degrees 840 and redirected angle=40 degrees 845 at the same side of the incident angle, where each angle is measured as the angle between a line parallel to the RIS and a line towards the source for the incident angle or the destination for the redirected angle. With appropriate phase shifts added by RIS elements, power gain at the destination is reduced to 0.0454 of power that would be received at the redirected angle=150 degrees, which is the specular reflection angle.

When utilizing high frequency for communication, the UE and the base station may frequently switch their respective beams to facilitate communication. The situation becomes more challenging during a handover (HO) process, especially when facing a HO ping-pong (HOPP) problem as shown in FIG. 9, or during dual-connectivity (DC) communication where the UE needs to maintain multiple beams in the direction of different base stations. FIG. 9 shows a UE 930 located in a region that is served by a first base station 910 and a second base station 920. If the UE 930 moves within a local area indicated by arrow 925, the UE 930 may determine that a signal from the first base station 910 is better than a signal from the second base station 920 on some occasions and a signal from the second base station 920 is better than a signal from the first base station 910 at other times. This may cause the UE 930 to be frequently handed over from the first base station 910 to the second base station 920 and vice versa.

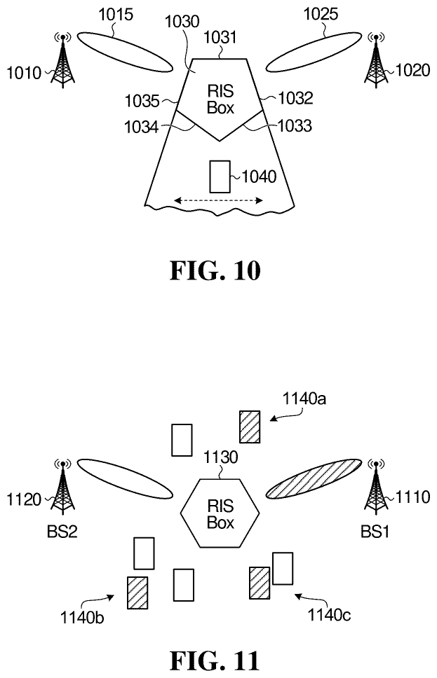

Based on situations as those discussed above, it may be of interest to reduce the beam switching by having a RIS box that may receive the signals from different directions or sources and redirect them to one or more destinations as shown in FIG. 10. In FIG. 10, a first base station 1010 and a second base station 1020, a RIS box 1030 with five edges 1031, 1032, 1033, 1034, 1035, and a UE 1040 are in a local proximity to one another. Each of the edges of the RIS box 1030 may be configured to be in a particular transmission mode, for example a reflection mode or a refraction mode. When in a reflection mode, the incident signals impinging a RIS edge are redirected off of the surface of the RIS edge. When in a refraction mode, the incident signals impinging a RIS edge are redirected through the surface of the RIS edge. At a particular point in time depicted in FIG. 10, two of the RIS edges 1031 and 1032 are configured to be in a reflective mode and the other three of the RIS edges 1033, 1034 and 1035 are configured to be in a refractive mode. Based on this configuration, a signal on a beam 1015 from the first base station 1010 is refracted by RIS edge 1035 and redirected to pass through either RIS edge 1032 or 1034, which may depend on where the UE 1040 is located. A signal on a beam 1025 from the second base station 1020 is reflected by RIS edge 1031 or 1032 so that signal will not reach the UE 1040. By controlling the reflection and refraction modes of different RIS edges, the UE 1040 may remain connected with the first base station 1010 without facing the HOPP problem.

Furthermore, by switching the modes of the RIS edges at different times, a UE 1040 may have dual connectivity (DC) with both base stations 1010 and 1020 while using the same beam to receive signals from both base stations 1010 and 1020 as the UE 1040 is directing a UE receive beam in a singular direction toward the RIS box 1030 such that the UE 1040 receives the signals from the RIS box 1030, without having to change the UE receive beam direction.

FIG. 11 illustrates an example situation where a first base station 1110 and a second base station 1120 communicate with one or more UEs 1140a, 1140b, 1140c without facing interference from different base stations or having the UEs frequently performing HO between the first and second base stations as the UEs move the regions that may be covered by both of the base station 1110 and 1120. A RIS box 1130 with six RIS edges (RIS edge #1, RIS edge #2, RIS edge #3, RIS edge #4, RIS edge #5 and RIS edge #6 as shown in FIG. 4) is shown that is configured to aid in managing these challenges. While the RIS box 1130 has six edges in the example of FIG. 11, it is understood that a RIS box may have greater than six edges or less than six edges in other implementations.

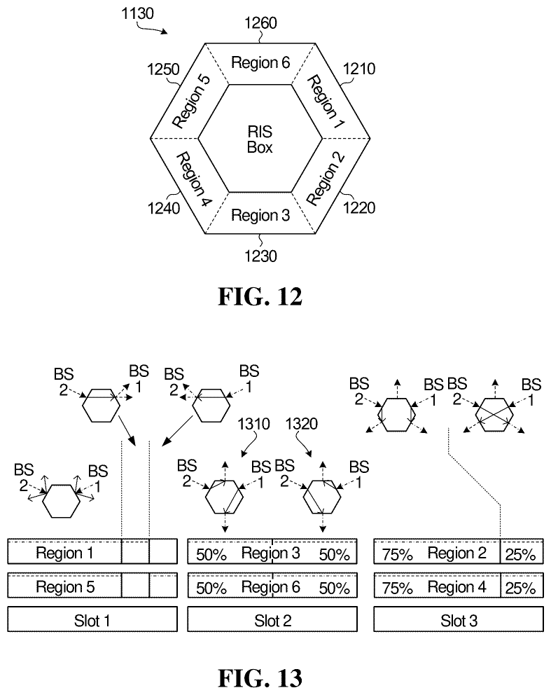

The coverage area of the RIS box 1130 may be divided into multiple regions 1210, 1220, 1230, 1240, 1250, and 1260, for example as shown in regard to the example RIS box 1130 in FIG. 12. The six regions represent physical areas that are covered by the six different edges (RIS edge #1, RIS edge #2, RIS edge #3, RIS edge #4, RIS edge #5 and RIS edge #6). As a result, each region 1210, 1220, 1230, 1240, 1250, and 1260 of the coverage area covers the reflection angles near its bore side, which maximizes the RIS effective aperture.

To facilitate communication from each base station to the UEs in the different regions, different time slots may be allocated with reflection or refraction mode configuration information such that each region is covered by both BSs, but during different time slots.

An example time slot allocation is shown in FIG. 13. The time slot allocation shows a portion of a time domain resource in FIG. 13 that includes three time slots, Slot 1, Slot 2 and Slot 3. Each time slot is further divided into two or more sub-slots. For example, in Slot 1, the slot is divided into three sub-slots, Slot 2 is divided into two sub-slots and Slot 3 is divided into two sub-slots. For a given slot, in a first sub-slot, two regions are covered by at least two base stations. Then, in a second or subsequent sub-slot, two different regions are covered by the at least two base stations. As an example, in FIG. 13, in Slot 2, in the first sub-slot, the RIS box allows a first base station coverage for Region 3 1230 and also allows a second base station coverage for Region 6 1260. In the second sub-slot, the RIS box allows the first base station coverage for Region 6 1260 and also allows the second base station coverage for Region 3 1260. These two sub-slots share the slot space, each having approximately 50% of Slot 2. In Slot 3, in the first sub-slot, the RIS box allows a first base station coverage for Region 2 1220 and also allows a second base station coverage for Region 4 1240. In the second sub-slot, the RIS box allows the first base station coverage for Region 4 1240 and also allows the second base station coverage for Region 2 1220. These two sub-slots share the slot space, the first sub-slot occupying 75% of Slot 3 and the second sub-slot occupying 25% of Slot 3. The sizes of the sub-slots may be selected based on different factors, e.g., the number of UEs, the resources for RS from different BSs or UE, the total throughput for data transmission from multiple UEs to the network, and other relevant factor.

Also shown in FIG. 13, located above the three slots and divided sub-slots in the figure are examples of how the RIS box edges are configured for either a reflective mode or a refractive mode to enable redirection of signals from the first base station and the second base station. Referring again to Slot 2, the arrangement of the RIS box for the first sub-slot, the network or the first base station configures 1310 the RIS box such that RIS edge 1 (using the labeling as applied in FIGS. 11 and 12) redirects the signal from the first base station to RIS edge 3, which is configured by the network or the first base station to redirect the signal from RIS edge 1 to the destination (e.g. desired UE) in region 3 1230. Also in the first sub-slot, the network or the second base station configures 1310 the RIS box such that RIS edge 5 redirects the signal from the second base station to RIS edge 6, which is configured by the network or the second base station to redirect the signal from RIS edge 5 to the destination (e.g. desired UE) in region 6 1260.

In the second sub-slot, the network or the second base station configures 1320 the RIS box such that RIS edge 5 redirects the signal from the second base station to RIS edge 3, which is configured by the network or the second base station to redirect the signal from RIS edge 5 to the destination (e.g. desired UE) in region 3 1230. Also in the second sub-slot, the network or the first base station configures 1320 the RIS box such that RIS edge 1 redirects the signal from the first base station to RIS edge 6, which is configured by the network or the first base station to redirect the signal from RIS edge 1 to the destination (e.g. desired UE) in region 6 1260.

The coverage of a region may be achieved via one wide beam being redirected from the RIS box or multiple narrow beams being redirected from the RIS box. This may depend on RIS box capabilities and RIS box configuration by the base stations or the network. In some embodiments, the time duration of the slots and sub-slots may be of different duration based on how the slots and sub-slots are configured. Also, in some embodiments, the order of the slots and sub-slot may change within a slot or among multiple slots.

It should be noted that for each region covered by the RIS box, for example a RIS edge corresponding to each region, multiple configurations may be applied to different RIS edges.

UEs located in each region covered by a given RIS edge may receive signals from the first base station and the second base station via the same UE receive beam. For example, referring to FIG. 10, UE 1040 may receive a signal from the first base station 1010 and the second base station 1020 on the same UE receive beam (not shown) because the RIS box 1030 redirects a signal from either base station in a same direction between the RIS box 1030 and the UE 1040. Therefore, in some embodiments, signals from different base stations may have QCL-type D relationship.

Furthermore, as the locations of the base stations and the RIS should likely be known to the network, and a link from the RIS box to a given UE is the same for both base stations, it is possible that the base stations are able to coordinate their transmission timing such that the signals from the base stations have the same average delay at the UE within a reasonable resolution. Therefore, in some embodiments, signals from different base stations may have QCL-type C relationship.

A multi-edge RIS structure (RIS box) and SEMS methods described herein may be helpful in different scenarios, such as but not limited to, enabling transmission of beams having a wide range of redirection angles by the RIS box, soft HO, and dual connectivity (DC) communication.

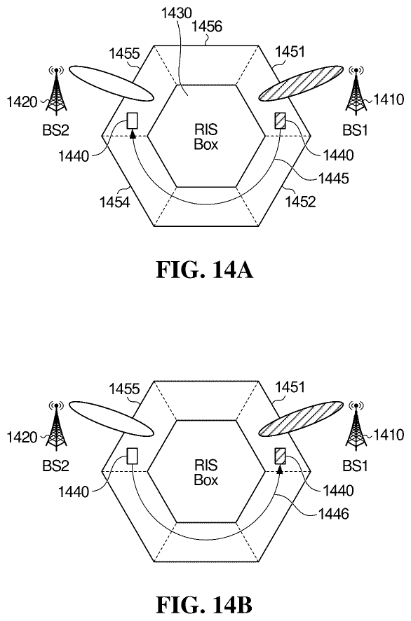

An example of how a HO ping-pong problem may be avoided will now be described with regard to FIGS. 14A and 14B. FIGS. 14A and 14B illustrate examples of a first base station 1410 and a second base station 1420 in proximity to a RIS box 1430. It should be understood that the drawing is not shown in real world scale. The RIS box 1430 is shown enlarged for descriptive purposes. In FIG. 14A, over a first duration of time, a UE 1440 is initially located in Region 1 1451 and is connected to the first base station 1410. The UE 1440 may receive signaling directly from the first base station 1410, signaling from the first base station 1410 via the RIS box 1430, or a combination of thereof. Over the first duration, the UE 1440 is shown moving along path 1445. While moving from Region 1 to Region 4, the UE 1440 remains connected with the first base station 1410 until entering Region 5 1455. HO may occur when the UE 1440 moves from Region 4 1454 to Region 5 1455. At a second point in time of the first duration, the UE 1440 is then connected with the second base station 1420 in Region 5 1455. In FIG. 14B, during a second duration, the UE 1440 is initially located in Region 5 1455 and is connected to the second base station 1420. While the UE 1440 moves along path 1446, the UE 1440 remains connected with the second base station 1420 until entering Region 1 1451. When the UE 1440 enters Region 1 1451, from Region 2 1452 (or Region 6 1456 if the UE travelled from Region 5 1455 to Region 6 1456 in a clockwise direction), HO occurs. As the UE 1440 may remain connected to either or both of the first and second base stations 1410 and 1420 as the UE moves through each of the regions, the HOPP problem is mitigated or avoided all together as the UE can stay connected to a single base station for a longer duration, if the signal strength and/or quality is sufficient.

In some embodiments, the UE may further have dual connectivity (DC) with two base stations in each region and can receive the signals from both base stations via the same beam.

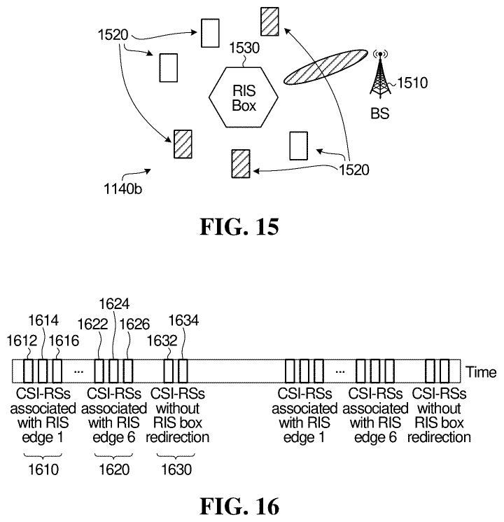

FIG. 15 illustrates a portion of a communication network that includes a base station 1510, multiple UEs 1520 and a multi-edge RIS box 1530 facilitating communication between the base station 1510 and the multiple UEs 1520.

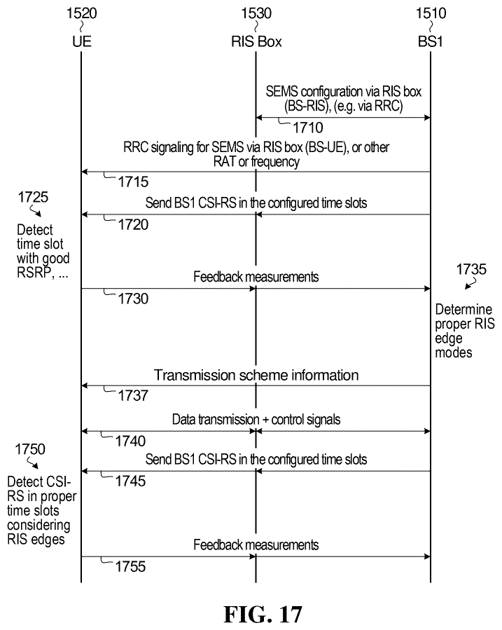

FIG. 17 shows a signaling diagram that includes signaling between the base station 1510, one of the multiple UEs 1520 and the RIS box 1530 as shown in FIG. 15, in which the signal may be used in some embodiments for channel measurements and data transmission.

At step 1710, the network or the base station 1510 sends configuration information (e.g. via RRC signaling) to the RIS box 1520 to redirect reference signals from the base station 1510 to cover different regions in a similar way as shown in FIG. 13. Such configuration information includes one or more of: a number of time slots and/or sub-slots, defining one or more RIS box edge transmission modes (e.g. a reflection mode or a refraction mode) in each time slot or sub-slot, RIS edge configuration information for each RIS box edge that indicates how a RIS box edge should redirect the incident signal from the base station 1510 to 1) another RIS box edge of the RIS box 1530 or 2) a specific direction to partially or fully cover a particular RIS box edge region, or redirect the redirected signal from another RIS box edge of the RIS box 1530 toward 1) another RIS box edge or 2) specific direction to partially or fully cover a particular RIS edge region.

At step 1715, the network or the base station 1510 sends configuration information to configure the reference signal (RSs) transmission to the UE 1520. In some embodiments, the configuration information may be sent as RRC signaling or other radio access technology (RAT) in the case of non-standalone network. A particular example of the type of reference signal may be a channel state information - reference signal (CSI-RS). However, the reference signal could be another type of reference signal, such as a tracking reference signal (T-RS), a phase tracking (PT-RS), or a demodulation reference signal (DMRS).

In the example of FIG. 17, the reference signal is a CSI-RS and therefore the configuration information includes one or more of: a sequence of CSI-RSs, timing for each CSI-RS transmission (may be towards RIS box or other directions) and the periodicity of the RS transmission, and an association between an edge of the RIS box 1530 and the timing for a group of CSI-RSs that are redirected by that RIS edge to cover one or more regions. In some embodiments, the base station 1510 and/or the network may send configure information regarding the CSI-RSs that will be sent directly from the base station 1510, i.e. not redirected by the RIS box 1530). In some embodiments, the configuration information is sent as RRC signaling. More generally, when the reference signal is a different type of reference signal, references to the CSI-RS in step 1715, and other subsequent steps in FIG. 17, would of course pertain to that different type of reference signal.

FIG. 16 illustrates an example of allocation of time domain resources for CSI-RSs being transmitted by the base station 1510. In a first time slot 1610 there are three sub-slots 1612, 1614, 1616 for transmission of CSI-RS that will be redirected by RIS edge #1. In a subsequent time slot 1620 there are three sub-slots 1622, 1624, 1626 for transmission of CSI-RS that will be redirected by RIS edge #6. Between the first time slot 1610 and the subsequent time slot 1620, there are time slots (not shown) for transmission of CSI-RS that will be redirected by RIS edges #2 to #5. Subsequent to the time slot 1620 for RIS edge #6, there is a time slot 1630 with two sub-slots 1622 and 1624 for transmission of CSI-RS that will not be redirected by the RIS box 1530 and that will be received directly by the UE 1520. The expression “received directly” includes received over a direct line of sight path, but may also mean reflected off an object in the environment, such as a building. It is just intended to mean that the signal is not redirected by the RIS box. While there are three sub-slots in the allocated CSI-RS slots for the various RIS edges and two sub-slots for the CSI-RS that will not be redirected by the RIS box, and 6 edges in the example of FIG. 16, it is to be understood that these are only example values and there could be more or less sub-slots allocated per edge and more or fewer RIS edges in a given implementation.

At step 1720, the base station 1510 transmits the CSI-RSs considering the timing configuration information in step 1715. The CSI-RSs are redirected by the RIS box 1530 to cover different regions as configured in step 1710. In some embodiments, the base station 1510 may send some CSI-RS in other directions, that are not redirected by the RIS box 1530.

At step 1725, the UE 1520 receives the CSI-RSs and measures the signal strengths (e.g. reference signal received power (RSRP), received signal strength indicator (RSSI), signal-to-noise ratio (SNR)) and feeds back such measurements to the base station at step 1730. More generally, the UE 1520 measures a channel property. In some embodiments, the UE 1520 may also use the measurements to determine signal or channel quality as well in the form of channel state information (CSI) or channel quality indicator (CQI), which could be fed back to the base station 1510.

The measurement and other feedback information may be based on one or more of the following situations. In some embodiments, the UE 1520 may use the same beam, or a nearby beam, for reception of CSI-RS from the same RIS edge. In some embodiments, the UE 1520 may feedback identification of the time slot of one or more received RSs with acceptable RSRP.

At step 1735, based on the UE measurements and feedback information received in step 1730, the network or base station 1510 may determine a proper transmission scheme to be used going forward and inform 1737 the UE 1520. The base station 1510 may inform the UE 1520 via one or more of the following types of signaling: RRC; downlink control information (DCI); and MAC control element CE (MAC CE). The transmission scheme case may be one or more of the following:
direct communication between the base station 1510 and one or more UE 1520 without RIS box 1530 help or communication with the help of the RIS box 1530. However, other transmission schemes may also be possible. Moreover, other information about the transmission scheme, such as, but not limited to, MCS, may be included with the transmission scheme information.

During data transmission, for example that may occur as shown at step 1740, beams between the nodes (i.e. the base station 1510, the UE 1520, and the RIS box 1530) may be refined and a channel may be tracked using different RSs like CSI-RS, PT-RS, T-RS, and demodulation reference signal (DMRS). The DMRS may be associated with any downlink channel such as a physical downlink control channel (PDCCH). Beam or channel updates may involve additional steps of the base station 1510 transmitting CSI-RS, as in step 1745, and the UE 1520 detecting the CSI-RS, as in step 1750, and forwarding feedback measurements to the base station, as in step 1755.

In some embodiments, when the UE 1520 is receiving signaling from the base station 1510 via the RIS box 1530, and when the UE 1520 knows which RIS edge redirects the signals to the UE 1520, the UE 1520 may utilize the configuration information in step 1715 to prepare for RS reception (e.g. search for RSs of the current RIS edge (through which the UE is receiving data) and the two RIS edges beside this RIS edge). In some embodiments, UE knowledge of the RIS edge through which the UE 1520 communicates with another node may be obtained from previous CSI-RS measurements or from the location/position information of the RIS box 1530 and a UE 1520. In some embodiments, the base station 1510 may inform the UE 1520 about the RS scheduling for different RIS edges, i.e. as the base station 1510 knows the RSs for the RIS edge that currently redirects to the UE 1520 and the scheduling of the RSs transmission of two adjacent RIS edges in addition to the current RIS edge, the base station 1510 may share such timing information with the UE 1520. Hence, the UE 1520 may use such information to search for RSs that are redirected by the current RIS edge and two RIS edges adjacent to the current RIS edge.

For example, if a UE location is known by the base station 1510 or network, with some accuracy, via different methods like sensing, global positioning system (GPS) information, etc., and the network also knows a shape of the RIS box 1530 and a location of the RIS box 1530, the base station 1510 or network may estimate the one or more edges of the RIS box that may be used for communication with that UE 1520. Then, the base station 1510 or network may provide such RIS edge information to the UE 1520. In some embodiments, this RIS edge information may be sent via RRC signaling.

In some embodiments, the base station 1510 may reconfigure the RIS box to redirect a transmission via a different RIS edge based on feedback information from the UE such as in steps 1730 and 1755.

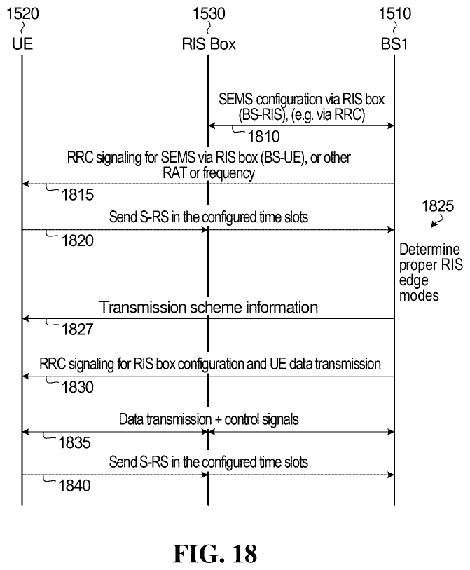

Referring once again to the arrangement of the base station 1510, the multiple UEs 1540 and the RIS box 1530 in FIG. 15, another scenario includes one or more UEs 1520 sending reference signals to the base station 1510 with the help of RIS box 1530 to facilitate data transmission. The signaling for such scenario is explained with reference to FIG. 18.

At step 1810, the network or the base station 1510 sends configuration information to the RIS box to redirect the RSs from the UE 1520 to the base station 1510 considering the UE 1520 is located in one of the regions that may be covered by different edges of the RIS box 1530. The configuration information may be sent as RRC signaling. The configuration information includes one or more of: a number of time slots and/or sub-slots, defining one or more RIS edge modes (e.g. reflection or refraction) in each time slot or sub-slot, RIS box edge configuration information for each RIS edge that indicates how a RIS box edge should redirect the incident signal from the base station 1510 to 1) another RIS box edge or 2) a specific direction to partially or fully cover a particular RIS box edge region, or redirect the redirected signal from another RIS box edge toward 1) another RIS edge or 2) specific direction to partially or fully cover a particular RIS box edge region.

At step 1815, the network or base station 1510 sends configuration information to configure the RSs transmission from the UE 1520 to the base station 1510. The configuration information may be RRC signaling or other radio access technology (RAT) in the case of non-standalone network. An example of a RS transmission from the UE 1520 to the base station 1510 may be a sounding reference signal (S-RS). However, the reference signal could be another type of reference signal, such as a tracking reference signal (T-RS), a phase tracking (PT-RS), or a demodulation reference signal (DMRS). The DMRS may be associated with any uplink channel such as a physical uplink control channel. The RS transmission from the UE 1520 to the base station 1510 or via the RIS box 1530.

In the example of FIG. 18 the reference signal is a S-RS and therefore the configuration information includes a sequence of S-RSs, timing for each S-RS transmission (may be towards RIS box or other directions) and the periodicity of the RS transmission, and an association between an edge of the RIS box 1530 and the timing for a group of S-RSs that are redirected by that RIS edge to cover one or more regions. More generally, when the reference signal is a different type of reference signal, references to the S-RS in step 1815, and other subsequent steps in FIG. 18, would of course pertain to that different type of reference signal.

In some embodiments, the base station 1510 and/or the network may send configuration regarding the S-RSs that will be sent directly from the base station 1510, i.e. not redirected by the RIS box 1530. In some embodiments, the configuration may be sent as RRC signaling.

At step 1820, the UE 1520 transmits the S-RSs considering the timing configured in step 1815 and the S-RS are redirected by the RIS box 1530 as configured in step 1810. In some embodiments, the UE 1520 may send some S-RS in other directions, that are not redirected by the RIS box 1530.

At step 1825, the base station 1510 receives the S-RSs and measures the signal strengths (e.g. RSRP, RSSI, SNR, etc.) and based on these measurements, the network or the base station 1510 may determine an appropriate transmission scheme and informs the UE 1520 of the transmission scheme in step 1830. In some embodiments, the UE 1520 may also use the measurements to determine signal or channel quality as well in the form of channel state information (CSI) or channel quality indicator (CQI). In some embodiments, the base station 1510 informs 1827 the UE 1520 of the transmission scheme via one or more of the following types of signaling: RRC; DCI; and MAC CE. The transmission scheme case may be one or more of the following: direct communication between the base station 1510 and one or more UE 1520 without redirection by the RIS box 1530 or communication with redirection by the RIS box 1530. However, other transmission schemes may also be possible. Moreover, other information about the transmission scheme, such as, but not limited to, MCS, may be included with the transmission scheme information.

At step 1835, the base station 1510 or network may inform the UE 1520 regarding which edge of the RIS box 1530 the UE 1520 and the base station 1510 will be communicating. Such communication may be based on the determination in step 1825.

During data transmission, for example that is shown at step 1835, beams between the nodes (i.e. the base station 1510, the UE 1520, and the RIS box 1530) may be refined and the channel may be tracked using different RSs like S-RS and demodulation reference signal (DMRS). This may involve additional steps of the UE 1520 transmitting S-RS as in step 1840 and the base station 1510 detecting the S-RS based on the received S-RS and performing measurements of the detected S-RS.

In some embodiments, when the UE 1520 is connected via the RIS box 1530 and when the UE 1520 knows the particular RIS box edge that redirects from the UE 1520 to the base station 510, the UE 1520 may utilize the information in step 1815 to prepare for RS transmission, e.g. transmit S-RS via the current RIS edge (through which a UE 520 is transmitting data) and the two RIS edges that are adjacent the current RIS edge.

In some embodiments, the base station 510 may reconfigure the RIS box 530 to redirect transmission from the UE 520 via a different RIS edge.

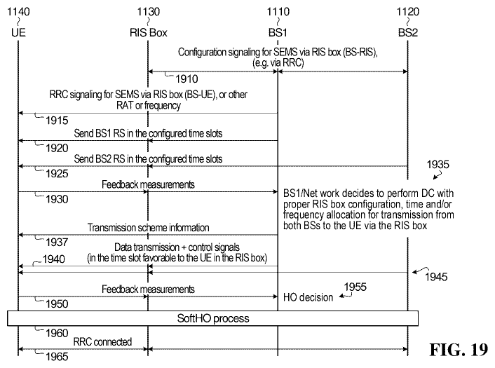

While FIG. 17 and the accompanying description provided an explanation of a single base station corresponding with a UE via a RIS box, FIG. 19 will now be used to describe a scenario pertaining to two base stations corresponding with a UE via a RIS box. An example of this scenario is shown in FIG. 11, where one or both of the two base stations 1110 and 1120 may communicate with UEs 1140a, 1140b, 1140c in proximity to the RIS box 1130. It should be understood that methods and associated signaling may be extended to more than two base stations.

FIG. 19 shows signaling between a first base station 1110, a second base station 1120, a RIS box 1130, and a UE 1140. At step 1910, the network, or at least one of the first base station 1110 or the second base station 1120, sends configuration information to configure the RSs transmission from the first and second base stations 1110 and 1120. The configuration information may be sent via RRC signaling. In some embodiments, the configuration information may include one or more of: a number of time slots and/or sub-slots, defining one or more RIS edge modes (e.g. reflection or refraction) in each time slot or sub-slot, RIS box SEMS configuration information for each RIS box edge that indicates how a RIS box edge should redirect the incident signal from the first base station 1110 to 1) another RIS box edge of the RIS box 1130 or 2) a specific direction to partially or fully cover a particular RIS box edge region, or redirect the redirected signal from another RIS box edge toward 1) another RIS box edge of the RIS box 1130 or 2) specific direction to partially or fully cover a particular RIS box edge region.

At step 1915, the network and at least one of the first base station 1110 or the second base station 1120 send configuration information to configure the RS between one or more base stations and the UE 1140. The configuration information may be sent as RRC signaling or other radio access technology (RAT) in the case of non-standalone network. An example of the type of reference signal may be a channel state information—reference signal (CSI-RS). However, the reference signal could be another type of reference signal, such as a tracking reference signal (T-RS), a phase tracking (PT-RS), or a demodulation reference signal (DMRS).

In the example of FIG. 19, the reference signal is a CSI-RS and therefore the configuration information includes one or more of: a sequence of CSI-RSs, timing for each CSI-RS transmission (may be towards RIS box 1130 or other directions) and the periodicity of the RS transmission, and an association between an edge of the RIS box 1130 and the timing for a group of CSI-RSs that are redirected by that RIS edge to cover one or more regions. More generally, when the reference signal is a different type of reference signal, references to the CSI-RS in step 1915, and other subsequent steps in FIG. 19, would of course pertain to that different type of reference signal.

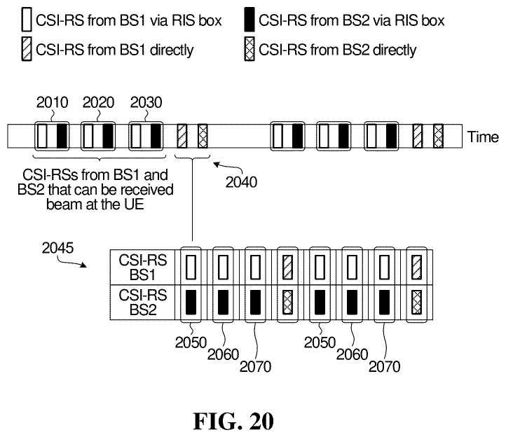

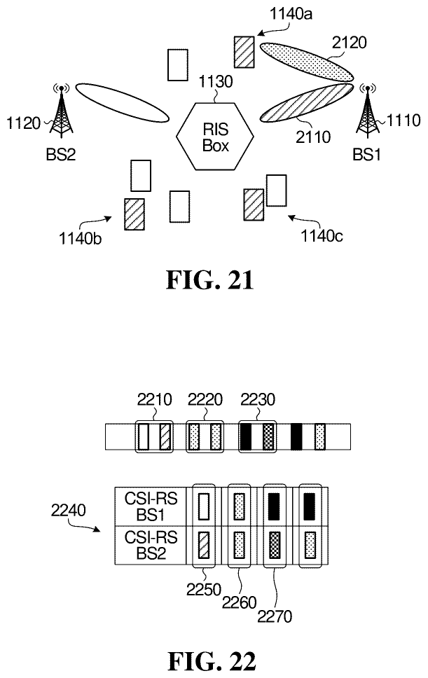

The group of CSI-RSs from one or more base stations may be received via the same beam at the UE. In some embodiments, CSI-RS from the first base station 1110 and the second base station 1120 are related via QCL-type D. Such a grouping may be further explained with reference to FIGS. 20 and 21.

FIG. 20 illustrates an example of allocation of time domain resources for CSI-RSs being transmitted by the first base station 1110 and the second base station 1120. In a first time slot 2010 there are two sub-slots, one sub-slot for each of the base stations, for transmission of CSI-RS that will be redirected by the RIS box 1130. In a second time slot 2020 there are two sub-slots, one sub-slot for each of the base stations, for transmission of CSI-RS that will also be redirected by the RIS box 1130. In a third time slot 2030 there are two sub-slots, one sub-slot for each of the base stations, for transmission of CSI-RS that will also be redirected by the RIS box 1130. After the third time slot 2030, there is a time slot 2040 with two sub-slots for transmission of CSI-RS that will not be redirected by the RIS box 1130 and that will be received directly by the UE 1140. While there are two sub-slots in the allocated CSI-RS slots for transmission via the RIS box 1130 and two sub-slots for the CSI-RS that will not be redirected by the RIS box 1130, it is to be understood that these are only example values and there could be more or less sub-slots allocated in a given implementation. In addition, in some embodiments, not all base stations may use sub-slots within slots for different BS transmission. For example, a first base station may send multiple RSs (that use and do not use the RIS box) at a first time and then a second base station may send multiple RSs at a second different time, with and without RIS help.

FIG. 20 also includes a table 2045 that shows how CSI-RSs may be grouped for the combination of RSs transmitted by the first and second base stations 1110 and 1120. For instance, a first group 2050 includes a grouping of CSI-RS for each of the first and second base stations 1110 and 1120, a second group 2060 includes a grouping of CSI-RS for each of the first and second base stations 1110 and 1120, and a third group 2070 includes a grouping of CSI-RS for each of the first and second base stations 1110 and 1120.

The configuration information sent in step 1915 may also include a relative average delay difference between CSI-RSs of the same group from the first base station 1110 and the second base station 1120 arriving at the UE 1140. In some embodiments, when the locations are known for both the first base station 1110 and the second base station 1120 and the RIS box 1130, the network or at least one of the first or second base station 1110 and 1120 may arrange the CSI-RS transmission from both base stations such that they have the same average delay. In some embodiments, the network or at least one of the first or second base stations 1110 and 1120 may inform the UE 1140 about the relative difference of the average delay to the UE 1140 between the CSI-RS from first base station 1100 and the CSI-RS from the second base station 1120. With such information, the CSI-RSs from the two base stations may have QCL-type C relationship.

In some embodiments, it is also possible for one or both of the base stations and/or the network to send signaling to configure the reference signals (i.e. CSI-RSs) that will be sent directly from one or more base stations (i.e. without RIS help) as shown in FIG. 21. The configuration signaling may be RRC signaling. FIG. 21 is similar to FIG. 11 with the first base station 1110, the second base station 1120, the multiple UEs 1140a, 1140b, 1140c and the RIS box 1130. In addition to reference signals (i.e. CSI-RSs) being sent on beam 2110 from the first base station 1110 to the RIS box 1130, reference signals (i.e. CSI-RSs) are also sent 2120 from the first base station 1110 directly to UE 1140a without being redirected by the RIS box 1130.

Referring again to FIG. 19, at step 1920, the first base station 1110 transmits the reference signals (i.e. CSI-RSs) based on the timing configured in step 1915, which are redirected by the RIS box 1130 to cover one or more regions as configured in step 1910. At step 1925, the second base station 1120 transmits the reference signals (i.e. CSI-RSs) based on the timing configured in step 1915, which are redirected by the RIS box 1130 to cover one or more regions as configured in step 1910. While signaling is shown sent from the first base station 1110 first and the second base station 1120 second, this is not necessarily always the case, as more generally the base stations may send the RSs in any order.

The UE 1140 receives the reference signals considering the grouping of the reference signals as configured in step 1915. The reference signals may be CSI-RSs from the first and second base stations 1110 and 1120 that may be received via the same (i.e., QCL-type D relationship between the CSI-RSs from the two BSs) and have the same average delay (i.e., QCL-type C relationship between the CSI-RSs from the two BSs) or with some difference in the average delay. The UE 1140 measures the strength (e.g. RSRP, RSSI, SNR, etc.) of the received reference signals and feeds back at step 1930 one or more of the following pieces of information. One feedback information is an indication of one or more reference signals that are received directly (without RIS box help) with appropriate signal strength (i.e. RSRP, RSSI, SNR that satisfy a threshold for appropriate signal strength). In some embodiments, the UE 1140 may also use the measurements to determine signal or channel quality as well in the form of channel state information (CSI) or channel quality indicator (CQI), which could be fed back to one of the first and second base stations 1110 and 1120.

Another feedback information is an indication of one or more group indices that identifies reference signals from multiple base stations with good signal strength. FIG. 22 illustrates an example of allocation of time domain resources for CSI-RSs being transmitted by the first base station 1110 and the second base station 1120. In a first time slot 2210 there are two sub-slots, one sub-slot for each of the base stations, for transmission of CSI-RS that will be redirected by the RIS box 1130. In a second time slot 2220 there are two sub-slots, one sub-slot for each of the base stations, for transmission of CSI-RS that will also be redirected by the RIS box 1130. In a third time slot 2230 there are two sub-slots, one sub-slot for each of the base stations, for transmission of CSI-RS that will also be redirected by the RIS box 1130. FIG. 22 also shows a table 2240 indicating how CSI-RSs may be grouped for the combination of reference signals transmitted by the two base stations 1110 and 1120. For instance, a first group 2250 includes a grouping of CSI-RS for each of the first and second base stations 1110 and 1120, a second group 2260 includes a grouping of CSI-RS for each of the first and second base stations 1110 and 1120, and a third group 2270 includes a grouping of CSI-RS for each of the first and second base stations 1110 and 1120. The progression from white or light grey to darker grey or black in the various groups is intended to qualitatively show increasing signal strength measured for the CSI-RS. Therefore, in the third column in table 2040 of FIG. 22 the darkest grey indicates a highest signal strength. In some embodiments, such information may be helpful if dual connectivity (DC) is to be used for data transmission.

Another feedback information is an indication of a signal strength of the reference signals from multiple base stations within the group(s) in step 1930.

Based on the UE feedback in step 1930, the network or the first base station 1110 may determine at step 1935 a transmission scheme for data transmission between the first base station 1110 and the UE 1140 and inform the UE 1140 of the transmission scheme. In some embodiments, the first base station of the network at step 1935 may decide to perform dual connectively (DC) with proper configuration, time and/or frequency allocation for transmission from both the first base station 1110 and the second base station 1120 to the UE 1140 via the RIS box 1130 The network or the first base station 1110 may inform 1937 the UE 1140 via RRC signaling.

In some embodiments, the transmission scheme may involve maintaining a link between the first base station 1110 and the UE 1140 via the RIS box 1130 for data transmission with a modulation and coding scheme (MCS) and particular RIS box configuration (e.g. the time duration in the RIS box redirects the signal from the first base station 1110 to the UE 1140) based on the UE feedback in step 1930.

In some embodiments, the transmission scheme may involve changing to a direct link from the first base station 1110 to the UE 1140 that does not use the RIS box 1130 to redirect the signal.

In some embodiments, the transmission scheme may involve deploying dual connectivity (DC) for the UE 1140 with the first base station 1110 and the second base station 1120 with selected transmission frequency and/or time slot from each of the first and second base stations 1110 and 1120 to the UE 1140. The first base station 1110 or the network may inform the UE 1140 that the UE 1140 may receive the signals from the first base station 1110 and the second base station 1120 via the same beam. In some embodiments, the first base station 1110, the second base station 1120 or the network may configure the RIS box 1130 to facilitate the DC communication. The configuration may comprise sending configuration information that includes one or more of: a time slot duration to redirect each base station signal to the UE 1140, each RIS edge configuration of the RIS box 1130 such that the RIS box 1130 redirects a signal from at least one of the first base station 1110 or the second base station 1120 to the UE 1140 with the same or different time or frequency resources.

In some embodiments, the transmission scheme may involve moving to a link from the second base station 1120 to the UE 1140 via the RIS box 1130 or a link from the second base station 1120 to the UE 1140 without redirection by the RIS box 1130 for data communication after performing soft handover.

It is to be understood that other transmission schemes may also be possible.

The UE 1140 receives the information 1937 about the transmission scheme from the first base station 1110, and then the UE 1140 determines the detection and decoding schemes for the data that is to be sent from one or more base stations.

At step 1940, the first base station 1110 and UE 1140 perform data transmission. At step 1945, the second base station 1120 and UE 1140 perform data transmission. These two steps are shown serially, but it is to be understood that this signaling could be in the order shown, a reverse order from that shown, i.e. from the second base station 1120 first, or in parallel, if the UE is capable of receiving both signals without interference. FIG. 19 shows a handover (HO) decision at step 1955 after data transmission from the first base station 1110 or the second base station 1120 to the UE 1140. This scenario may occur as the first and second base stations 1110 and 1120 may send DMRS to measure a channel, and based on a channel quality indicator (CQI) fed back from the UE 1140, such as shown in step 1950, the network or first base station 1110 may determine to switch or select one base station for communication between the UE 1140 and the network.

After the HO occurs, the second base station 1120 is connected to the UE 1140 and data transmissions can occur between the second base station 1120 and the UE 1140 via the RIS box 1140 and/or directly between the second base station 1120 and the UE 1140 without the RIS box redirecting the signalling.

Examples of devices (e.g., UE, BS) to perform the various methods described herein are also disclosed.

For example, a device may include a memory to store processor-executable instructions, and a processor to execute the processor-executable instructions. When the processor executes the processor-executable instructions, the processor may be caused to perform the method steps of one or more of the devices as described herein, e.g., in relation to FIGS. 1 to 4 and 17. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising
transmitting, by a network side device, first configuration information to a set of Reconfigurable Intelligent Surfaces (RISs) in proximity to one another, each RIS of the set of RISs serving a region of a plurality of regions that is covered by the set of RISs, the first configuration information comprising information for configuring the set of RISs to redirect a signal between the network side device and a terminal side device; and
transmitting, by the network side device, second configuration information to the terminal side device, the second configuration information comprising information to configure transmission of at least one reference signal (RS) between the network side device and the terminal side device in at least one time slot.

2. The method of claim 1, wherein the first configuration information comprises at least one of:
a number of time slots during which the at least one RS will be transmitted; or
an identification of a mode in which each RIS of the set of RISs is to function in each time slot; and
wherein:
each RIS is capable of redirecting an incident signal from the network side device to another RIS of the set of RISs or in a direction to partially or fully cover a region covered by the RIS redirecting the incident beam; or
each RIS is capable of redirecting a redirected signal from a first RIS of the set of RISs toward a second RIS of the set of RISs or a direction to partially or fully cover a region covered by the first RIS redirecting the redirected incident beam.

3. The method of claim 1, wherein the first configuration information comprises a number of sub-slots per time slot during which the at least one RS will be transmitted.

4. The method of claim 1, wherein the second configuration information comprises at least one of:
an identification of a sequence of RSs;
an indication of timing for transmission of an RS;
an indication of periodicity of transmission of an RS; or
an identification of an association between a RIS of the set of RISs and a timing for a group of RSs to be redirected by the RIS to cover at least one region of the plurality of regions covered by the set of RISs.

5. The method of claim 1, wherein transmission of the at least one RS between the network side device and the terminal side device comprises:
a downlink transmission of the at least one RS from the network side device to the terminal side device; or
an uplink transmission of the at least one RS from the terminal side device to the network side device.

6. An apparatus, comprising:
at least one processor; and
at least one computer-readable medium having stored thereon, computer executable instructions, that when executed cause the at least one processor to:
transmit first configuration information to a set of Reconfigurable Intelligent Surfaces (RISs) in proximity to one another, each RIS of the set of RISs serving a region of a plurality of regions that is covered by the set of RISs, the first configuration information comprising information for configuring the set of RISs to redirect a signal between the network side device and a terminal side device; and
transmit second configuration information to the terminal side device, the second configuration information comprising information to configure transmission of at least one reference signal (RS) between the network side device and the terminal side device in at least one time slot.

7. The apparatus of claim 6, wherein the first configuration information comprises at least one of:
a number of time slots during which the at least one RS will be transmitted; or
an identification of a mode in which each RIS of the set of RISs is to function in each time slot; and
wherein:
each RIS is capable of redirecting an incident signal from the network side device to another RIS of the set of RISs or in a direction to partially or fully cover a region covered by the RIS redirecting the incident beam; or
each RIS is capable of redirecting a redirected signal from a first RIS of the set of RISs toward a second RIS of the set of RISs or a direction to partially or fully cover a region covered by the first RIS redirecting the redirected incident beam.

8. The apparatus of claim 6, wherein the first configuration information comprises a number of sub-slots per time slot during which the at least one RS will be transmitted.

9. The apparatus of claim 6, wherein the second configuration information comprises at least one of:
an identification of a sequence of RSs;
an indication of timing for transmission of an RS;
an indication of periodicity of transmission of an RS; or
an identification of an association between a RIS of the set of RISs and a timing for a group of reference signals to be redirected by the respective RIS to cover at least one region of the plurality of regions covered by the set of RISs.

10. The apparatus of claim 6, wherein transmission of the at least one RS between the network side device and the terminal side device comprises:
a downlink transmission of the at least one RS from the network side device to the terminal side device; or
an uplink transmission of the at least one RS from the terminal side device to the network side device.

11. A method comprising
receiving, by a terminal side device, configuration information from a network side device, the configuration information comprising information to configure transmission of at least one reference signal (RS) between the network side device and the terminal side device in at least one time slot via a set of Reconfigurable Intelligent Surfaces (RISs), each RIS of the set of RISs serving a region of a plurality of regions that is covered by the set of RISs.

12. The method of claim 11, wherein the configuration information comprises at least one of:
an identification of a sequence of RSs;
an indication of timing for transmission of an RS;
indication of periodicity of transmission of an RS;
an identification of an association between an RIS of the set of RISs and a timing for a group of reference signals to be redirected by that RIS to cover at least one region of the plurality of regions covered by the set of RISs.

13. The method of claim 11, wherein transmission of the at least one RS between the network side device and the terminal side device comprises:
a downlink transmission of the at least one RS from the network side device to the terminal side device; or
an uplink transmission of the at least one RS from the terminal side device to the network side device.

14. The method of claim 13, wherein the at least one RS transmitted in the downlink transmission comprises at least one of a channel state information reference signal (CSI-RS), a tracking reference signal (T-RS), a phase tracking (PT-RS), or a demodulation reference signal (DMRS).

15. The method of claim 14, wherein the configuration information includes additional configuration information from a second network side device to configure transmission of at least one RS between the second network side device and the terminal side device in at least one time slot via the set of RISs.

16. An apparatus, comprising:
at least one processor; and
at least one computer-readable medium having stored thereon, computer executable instructions, that when executed cause the at least one processor to:
receive configuration information from a network side device, the configuration information comprising information to configure transmission of at least one reference signal (RS) between the network side device and the terminal side device in at least one time slot via a set of Reconfigurable Intelligent Surfaces (RISs), each RIS of the set of RISs serving a region of a plurality of regions that is covered by the set of RISs.

17. The apparatus of claim 16, wherein the configuration information comprises at least one of:
an identification of a sequence of reference signals;
an indication of timing for transmission of an RS;
indication of periodicity of transmission of an RS;
an identification of an association between a RIS of the set of RISs and a timing for a group of reference signals to be redirected by the respective RIS to cover at least one region of the plurality of regions covered by the set of RISs.

18. The apparatus of claim 16, wherein transmission of the at least one RS between the network side device and the terminal side device comprises:
a downlink transmission of the at least one RS from the network side device to the terminal side device; or
an uplink transmission of the at least one RS from the terminal side device to the network side device.

19. The apparatus of claim 18, wherein the at least one RS transmitted in the downlink transmission comprises at least one of a channel state information reference signal (CSI-RS), a tracking reference signal (T-RS), a phase tracking (PT-RS), or a demodulation reference signal (DMRS).

20. The apparatus of claim 19, wherein the configuration information includes additional configuration information from a second network side device to configure transmission of at least one RS between the second network side device and the terminal side device in at least one time slot via the set of RISs.
